(19) United States
(12) Patent Application Publication
(10) Pub. No.: US 2018/0027418 A1
(43) Pub. Date: Jan. 25, 2018

(54) CHANNEL RESERVATION METHOD FOR UNLICENSED BAND COMMUNICATION, BASE STATION, AND USER TERMINAL

(71) Applicant: Sharp Kabushiki Kaisha, Sakai City, Osaka (JP)

(72) Inventors: BO LI, Shanghai (CN); QI JIANG, Shanghai (CN); RENMAO LIU, Shanghai (CN)

(21) Appl. No.: 15/541,927

(22) PCT Filed: Dec. 28, 2015
(86) PCT No.: PCT/CN2015/099196

§ 371 Date: Jul. 6, 2017

(30) Foreign Application Priority Data
Jan. 9, 2015 (CN) 201510013032.X

(51) Int. Cl. H04W 16/14; H04W 72/12; H04W 72/04

(52) U.S. Cl. CPC H04W 16/14; H04W 72/04; H04W 72/12

(57) ABSTRACT

The present invention provides an uplink channel reservation method used in a mobile communication system supporting an unlicensed carrier, as well as a base station and a user terminal that execute the method. The method includes: assessing whether an unlicensed carrier resource is free; and sending a channel reservation signal over the assessed free unlicensed carrier resource. According to embodiments of the present invention, it is ensured that an unlicensed carrier resource remains free during the period from the time when an unlicensed carrier is assessed to be free to the time when an uplink license is issued and comes into effect.

### TECHNICAL FIELD

The present invention relates to the technical field of radio communications. More particularly, the present invention relates to an uplink channel reservation method used in a mobile communication system supporting an unlicensed carrier, as well as a corresponding base station and a corresponding user terminal.

### BACKGROUND

A modern wireless mobile communication system presents two outstanding features: 1, broadband and high speed, for example, the bandwidth of a Fourth Generation (4G) wireless mobile communication system may reach 100 MHz, and the downlink speed is up to 1 Gbps; and 2, mobile interconnection, which pushes new services such as mobile Internet, mobile video-on-demand, and online navigation. The two features make higher requirements for a wireless mobile communication technology, mainly including: ultrahigh-speed wireless transmission, inter-regional interference suppression, reliable signal transmission in movement, distributed/centralized signal processing, and the like. In prospective enhanced 4G and 5G wireless mobile communication systems, in order to meet the foregoing development demands, various corresponding key technologies will begin to be proposed and argued about, and are worthy of being widely concerned by researchers in the present field.

In October, 2007, the International Telecommunications Union (ITU) ratified a Worldwide Interoperability for Microwave Access (WiMax) to become a fourth 3G system standard. The event happening during the last stage of a 3G era is, in reality, a preview of a 4G standard battle. In fact, since 2005, in order to meet the challenge of a wireless Internet Protocol (IP) technical flow representative of a wireless local area network and the WiMax, a 3GPP organization has initiated a brand-new system upgrade, namely standardization of a Long Term Evolution (LTE) system. This is a Quasi-4G system based on Orthogonal Frequency Division Multiplexing (OFDM). The first version was pushed out at the beginning of 2009, and began to be commercially available in succession all over the world in 2010. Meanwhile, the 3GPP organization had initiated standardization of the 4G wireless mobile communication system since the first half year of 2008. The system is called the Long Term Evolution Advanced (LTE) system. A key standardization document of a physical layer process of the system had been completed at the beginning of 2011. In November, 2011, the ITU announced, in Chongqing, China, that the LTE-A system and the WiMax system are two official standards of the 4G system. At present, a commercial process of the LTE-A system is being developed gradually around the world.

According to challenges in the coming ten years, the following development demands are substantial for an enhanced 4G wireless mobile communication system:
i. a higher wireless broadband speed is required, and optimization of local cell hot spot regions is emphasized;
ii. the user experience is further improved, particularly it is necessary to optimize communication services of cell boundary regions;
iii. in view of it being impossible to expand free bands 1000 times, it is necessary to continue researching a new technology capable of improving band utilization efficiency;
iv. high-frequency bands (5 GHz or above) will certainly come into use to obtain a larger communication bandwidth;
v. existing networks (2G/3G/4G, WLAN, WiMax, and the like cooperate to share data traffic;
vi. for different services, applications and service are specifically optimized;
vii. a system capability of supporting large-scale machine communications is supported;
viii. network planning and distribution are flexible, smart and inexpensive;
ix. a solution is designed to save the power consumption of a network and the battery consumption of a user terminal.

In a traditional 3GPP LTE system, data transmission is performed only over licensed bands/carriers. However, with the rapid increase of service traffic, the licensed bands/carriers may have particular difficulty meeting demands of the increased service traffic in hot spot regions of some cities. The 62^{nd} plenary session of 3GPPRAN discussed a new research project namely research (RP-132085) on unlicensed bands/carriers, which mainly aims to research non-standalone deployment utilizing LTE over the unlicensed bands, the non-standalone deployment referring to an association between communications over the unlicensed bands and serving cells over the licensed bands. A direct method is to follow a Carrier Aggregation (CA) mode in the LTE system to the greatest extent, namely, to deploy the licensed bands into a Primary Component Carrier (PCC) of a serving base station, and to deploy the unlicensed bands into a Secondary Component Carrier (SCC) of the serving base station.

However, application of the traditional LTE system to the unlicensed bands will encounter the following problems: due to a time sequence of an uplink transmission license and inevitable transmission delays in communications as well as some signaling interaction delays, devices such as WiFi may assess, within the period of idle time of an unlicensed carrier resource from the time when the unlicensed carrier resource is assessed to be free to the time before uplink transmission begins, a free channel to further transmit data over the unlicensed carrier, thus resulting in that the uplink transmission license, sent by a base station, over the unlicensed carrier cannot be executed or the uplink transmission over the unlicensed carrier fails.

Therefore, a method applicable to a communication system supporting an unlicensed carrier to ensure that an unlicensed carrier resource remains free during the period from the time when the unlicensed carrier is assessed to be free to the time when an uplink license is issued and comes into effect is needed.

### SUMMARY

To achieve the object described above, the present invention mainly provides, on the basis of LTE and LTE-A systems, an uplink channel reservation method used in a mobile communication system supporting an unlicensed carrier, as well as a base station and a user terminal for executing the method. It will be appreciated that the present invention is not limited to the LTE/LTE-A system, but may be applied to other communication systems supporting an unlicensed carrier instead, such as a prospective 5G cellular communication system.

In the solution according to the present invention, an unlicensed carrier resource reservation device (user terminal or base station) will decide whether, when, and how to send a certain signal for channel reservation, so as to ensure that an unlicensed carrier resource remains free, before uplink transmission of a Licensed Assistant Access (LAA) over the unlicensed carrier begins, for the LAA. In other words, the present invention provides a mechanism applicable to a communication system supporting an unlicensed carrier to send an unlicensed carrier resource reservation signal.

According to an aspect of the present invention, an uplink channel reservation method used in a mobile communication system supporting an unlicensed carrier is provided. The method includes: assessing whether an unlicensed carrier resource is free; and sending a channel reservation signal over the assessed free unlicensed carrier resource.

In some embodiments, the method is executed by a base station. Alternatively, in some other embodiments, the method is executed by a user terminal.

In some embodiments, the channel reservation signal may adopt a signal format defined in an LTE specification such as an assessment reference signal, a synchronizing signal, and a demodulation reference signal.

In some embodiments, the assessment is executed during the period of a Free Channel Assessment (CCA) symbol set by a protocol. The step of sending may be started from a first OFDM symbol after the CCA symbol.

In some embodiments, a maximum time of duration is also set for sending the channel reservation signal (e.g., sending is implemented by setting a timer). The channel reservation signal usually continues being sent until uplink transmission begins. If sending of the channel reservation signal has reached the maximum time of duration (e.g., the timer expires) but the uplink transmission has not begun yet, sending of the channel reservation signal is stopped.

In some embodiments, the method of the present invention is of a random access type. In some embodiments, the step of assessment is initiated randomly. Usually, it is assessed whether the unlicensed carrier resource is free during the period of a CCA symbol of a current sub-frame that decides to perform uplink transmission over the unlicensed carrier resource.

Alternatively, in some other embodiments, the method of the present invention is based on network uplink scheduling. In these embodiments, the step of assessment is initiated in response to the network uplink scheduling. Usually, it is assessed whether the unlicensed carrier resource is free during the period of a CCA symbol of an M^{th} sub-frame after a corresponding sub-frame for sending the uplink scheduling license, M being a positive integer greater than or equal to 1.

In an embodiment where the base station executes the uplink channel reservation method of the present invention, the base station may assess whether the unlicensed carrier resource is free during the period of a CCA symbol of a next frame with respect to a sub-frame for sending the uplink scheduling license.

In an embodiment where the user terminal executes the uplink channel reservation method of the present invention, the user terminal may assess whether the unlicensed carrier resource is free during the period of a CCA symbol in a sub-frame after the uplink scheduling license is received and parsed. In this case, the value of the parameter M may depend on a terminal capability, usually corresponding to a processing delay needed for the user terminal to receive and parse the uplink scheduling license sent by the base station.

Preferably, a terminal for performing uplink transmission over the assessed free unlicensed carrier resource is a terminal for executing CCA, or may be other terminals accessing the present cell.

According to a second aspect of the present invention, a base station is provided, which may be used for executing an uplink channel reservation method used in a mobile communication system supporting an unlicensed carrier. The base station may include: an assessment module, used for assessing whether an unlicensed carrier resource is free; and a sending module, used for sending a channel reservation signal aver the assessed free unlicensed carrier resource.

According to a third aspect of the present invention, a user terminal is provided, which may be used for executing an uplink channel reservation method used in a mobile communication system supporting an unlicensed carrier. The user terminal includes: an assessment module, used for assessing whether an unlicensed carrier resource is free; and a sending module, used for sending a channel reservation signal aver the assessed free unlicensed carrier resource.

### BRIEF DESCRIPTION OF THE DRAWINGS

Through detailed descriptions in conjunction with the accompanying drawings hereinbelow, the foregoing and other features of the present invention will become more obvious, where

FIG. 1 illustrates a flowchart of an uplink channel reservation method used in a mobile communication system supporting an unlicensed carrier according to an embodiment of the present invention;

FIG. 2 illustrates a time sequence diagram of an uplink channel reservation method implemented by a base station according to a first example of an embodiment of the present invention;

FIG. 3 illustrates a time sequence diagram of an uplink channel reservation method implemented by a base station according to a second example of an embodiment of the present invention;

FIG. 4 illustrates a time sequence diagram of an uplink channel reservation method implemented by a user terminal according to a third example of an embodiment of the present invention;

FIG. 5 illustrates a time sequence diagram of an uplink channel reservation method implemented by a user terminal according to a fourth example of an embodiment of the present invention;

FIG. 6 illustrates a time sequence diagram of an uplink channel reservation method implemented by a user terminal according to a fifth example of an embodiment of the present invention;

FIG. 7 illustrates a block diagram of a base station according to an embodiment of the present invention; and

FIG. 8 illustrates a block diagram of a user terminal according to an embodiment of the present invention.

In all the accompanying drawings of the present invention, identical or similar elements are denoted by identical or similar reference numerals.

### DETAILED DESCRIPTION

A mechanism applicable to a communication system supporting an unlicensed carrier to send an unlicensed carrier resource reservation signal, provided by the present invention, will be described hereinbelow in conjunction with the accompanying drawings and specific embodiments on the basis of LTE and LTE-A networks.

As described above, after an LTELAA assesses that an unlicensed carrier resource is free and before uplink LAA transmission begins, a certain time interval will often exist. If a WiFi device assesses that the unlicensed carrier resource is free and occupies the resource within the time interval, the LAA will not perform uplink transmission as scheduled by utilizing an unlicensed carrier channel after the time interval. Therefore, a corresponding channel reservation mechanism is needed to ensure that the unlicensed carrier resource is not occupied by a non-LAA device or other LAA devices during the period from the time when the unlicensed carrier resource is assessed to be free to the time when the uplink LAA transmission begins.

To this end, the present invention provides two solutions for sending an unlicensed carrier resource reservation signal. That is, a channel reservation signal may be sent by a terminal, or a channel reservation signal may be sent by a base station. The terminal may send an unlicensed carrier reservation signal in the following modes: a random access type mode, and a mode based on network uplink scheduling. The base station may also send an unlicensed carrier reservation signal in the following modes: a mode of sending, by the base station, an unlicensed carrier reservation signal once a free unlicensed carrier channel is assessed during channel assessment; and a mode based on a scheduling application reported by the terminal.

By taking an LTE mobile communication system and subsequent evolved versions thereof as application environment examples of the present invention, embodiments of the present invention will be described in detail hereinbelow. However, it is necessary to point out that the present invention is not limited to the following embodiments, but may be applied to any communication systems supporting an unlicensed carrier instead, such as a prospective 5G cellular communication system.

Terms “user terminal” and “user equipment” used herein may be used interchangeably or abbreviated as “terminal”.

Terms ‘channel reservation signal’ and ‘unlicensed carrier resource reservation signal’ used herein may be used interchangeably.

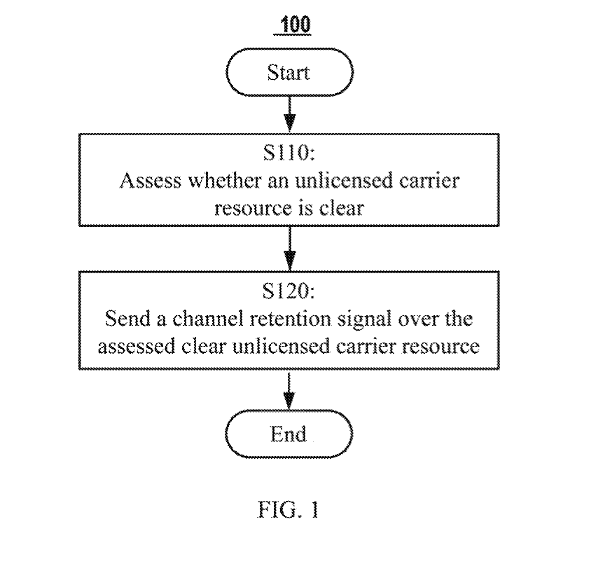

FIG. 1 illustrates a flowchart of an uplink channel reservation method 100 used in a mobile communication system supporting an unlicensed carrier according to an embodiment of the present invention.

As illustrated in FIG. 1, in step S110, it is assessed whether an unlicensed carrier resource is free (also abbreviated as “channel assessment” hereinbelow).

In step S130, a channel reservation signal is sent over the assessed free unlicensed carrier resource.

The method 100 may be executed by a base station or may be executed by a user terminal.

In an embodiment, in step S110, the channel assessment may be executed during the period of a CCA symbol set by a protocol. Under the condition that the free unlicensed carrier channel is assessed, the method moves on to step S130. In step S130, sending of the channel reservation signal may be started from a first OFDM symbol after the CCA symbol until the uplink transmission begins. The channel reservation signal may adopt, for example, a form of an assessment reference signal. Preferably, a maximum time of duration is also set for sending the channel reservation signal. If sending of the channel reservation signal has reached the set maximum time of duration but the uplink transmission has not begun yet, a corresponding timer expires and sending of the channel reservation signal is triggered to be stopped.

Under the condition that the base station executes the method 100, two triggering mechanisms may exist: (1) a random mode, or (2) a mode of a scheduling application reported by the terminal.

In the first triggering mode executed by the base station, the base station may initiate the channel assessment (namely step S110) at any time. For example, the base station may perform channel assessment during the period of a CCA symbol of a current sub-frame that decides to perform uplink transmission over the unlicensed carrier resource. Once the free unlicensed carrier channel is assessed, the base station may start to send an unlicensed carrier resource reservation signal from a first OFDM symbol after the CCA symbol until the uplink transmission begins or until the preset maximum time of duration is reached.

In the second triggering mode executed by the base station, the base station receives a scheduling application reported by the terminal, and then decides whether to agree with the scheduling application. If so, the base station sends an uplink scheduling license to the terminal. Then, the base station performs channel assessment during the period of a CCA symbol in a next sub-frame (namely step S110). Once the free unlicensed carrier channel is assessed, the base station may start to send an unlicensed carrier resource reservation signal from a first OFDM symbol after the CCA symbol until the uplink transmission begins or until the preset maximum time of duration is reached.

Under the condition that the user terminal executes the method 100, two triggering mechanisms may also exist: (1) a random mode, or (2) a mode based on network uplink scheduling.

In the first triggering mode executed by a user, the user terminal may initiate the channel assessment (namely step S110) at any time. For example, the user terminal may perform channel assessment during the period of a CCA symbol of a current sub-frame that decides to perform uplink transmission over the unlicensed carrier resource. Once the free unlicensed carrier channel is assessed, the terminal may start to send an unlicensed carrier resource reservation signal from a first OFDM symbol after the CCA symbol until the uplink transmission begins or until the preset maximum time of duration is reached.

In the second triggering mode executed by the user terminal, the user terminal sends an uplink scheduling application to the base station. If the base station agrees with the uplink scheduling application, the base station will send an uplink scheduling license to the terminal. If receiving and parsing the uplink scheduling license, the user terminal may initiate the channel assessment (namely step S110). Depending on a terminal processing capability, time delays of multiple sub-frames may be needed for the user terminal to receive and parse the uplink scheduling license sent by the base station. Meanwhile, depending on a resource scheduling algorithm of the base station, before or after channel assessment is executed, the base station may send uplink scheduling over the unlicensed carrier channel to other terminals accessing a cell thereof. Therefore, the user may perform channel assessment during the period of a CCA symbol of an M^{th} sub-frame after a corresponding sub-frame for sending the uplink scheduling license, and may start to perform uplink transmission over the unlicensed carrier channel from an M+1^{th} sub-frame after the corresponding sub-frame for sending the uplink scheduling license at the soonest. M may be a positive integer greater than or equal to 1. For example, M may be equal to 1 for a user terminal having a rapid processing capability, so uplink transmission may be started from a second sub-frame after the corresponding sub-frame for sending the uplink scheduling license at the soonest. M may be equal to 4 or other numbers for a user terminal having a common processing capability. Once the free unlicensed carrier channel is assessed, the terminal may start to send an unlicensed carrier resource reservation signal from a first OFDM symbol after the CCA symbol until the uplink transmission begins or until the preset maximum time of duration is reached. It is important to note that a terminal for performing uplink transmission over the assessed free unlicensed carrier resource is a user terminal for executing CCA, or may be other user terminals accessing the present cell.

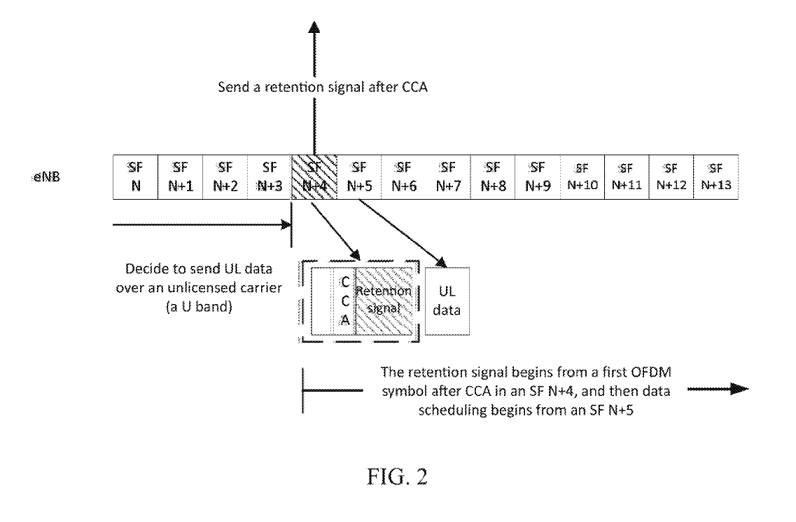

Examples of the embodiments of the present invention will be described hereinbelow with reference to FIG. 2 to FIG. 6.

The first example of the present invention will be described hereinbelow with reference to FIG. 2. FIG. 2 illustrates a time sequence diagram of an uplink channel reservation method according to a first example of an embodiment of the present invention. In the present example, channel assessment over an unlicensed carrier is initiated by a base station at any time, and accordingly, the base station sends a certain signal over the assessed free unlicensed carrier to retain a channel until a terminal starts to perform uplink signal transmission. This is an idea for an LAA device to intercept an unlicensed carrier channel at a network side and to perform transmission by utilizing the unlicensed carrier channel, namely an occupation-whilst-in use form. As illustrated in FIG. 2, once the base station decides to perform uplink transmission over an unlicensed carrier resource (a current sub-frame number is marked as N+4), the base station may perform channel assessment during the period of a CCA symbol set by a protocol for the current sub-frame (N+4). Time domain positions of multiple OFDM symbols for CCA may be set by a protocol or configured through network RRC signaling. When it is assessed that the unlicensed carrier channel is free through the CCA, the base station starts to send a certain signal (called “channel reservation signal”) set by the protocol from a first OFDM symbol after a CCA time period to retain occupation for the unlicensed carrier until the terminal officially starts to perform uplink transmission at an (N+4)+M^{th} (M being a positive integer greater than or equal to 1) sub-frame. Preferably, a maximum time of duration may be set for sending the channel reservation signal. No matter whether the terminal officially starts to perform uplink transmission at the (N+4)+M^{th} sub-frame, when continuous sending of the channel reservation signal has reached a maximum time of duration, a corresponding timer will expire to trigger to stop sending of the signal.

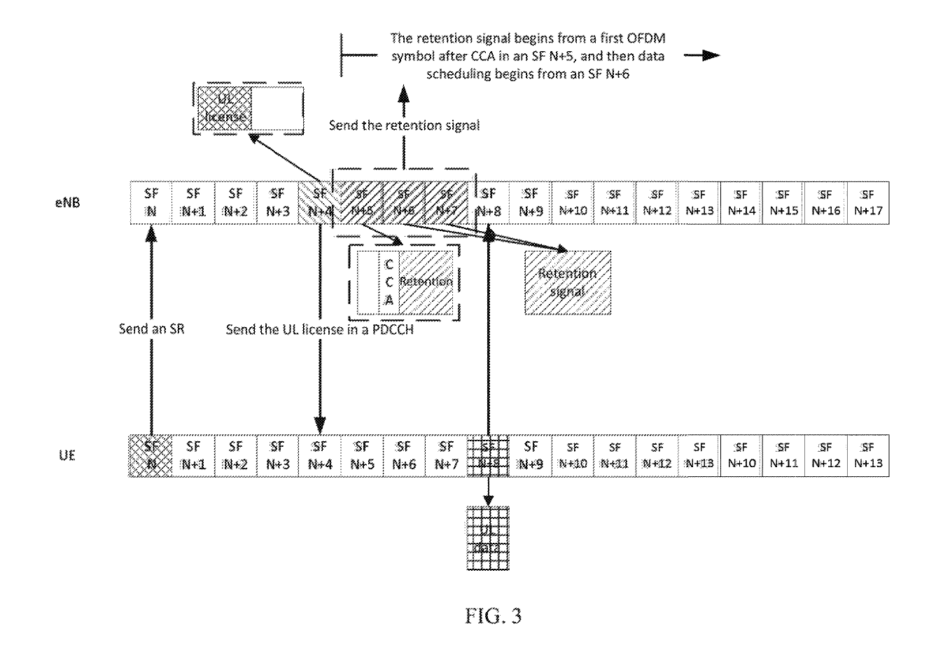

The second example of the present invention will be described hereinbelow with reference to FIG.3. FIG. 3 illustrates a time sequence diagram of an uplink channel reservation method according to a second example of an embodiment of the present invention. In the present example, channel assessment over an unlicensed carrier is initiated by a base station after sending an uplink scheduling signaling, and the base station sends a certain signal over the assessed free unlicensed carrier so as to retain a channel until a terminal receives the uplink scheduling signaling sent by the base station within a set or expected time and then starts to perform uplink signal transmission. This is another idea for an LAA device to intercept an unlicensed carrier channel at a network side and to perform transmission by utilizing the unlicensed carrier channel. That is, when the base station starts to send the uplink scheduling signaling, the LAA device retains the unlicensed carrier channel. As illustrated in FIG. 3, the terminal initiates an uplink scheduling application (SR) to the base station at a certain sub-frame, the number of the sub-frame being marked as N, so if the base station agrees with the scheduling application of the terminal in accordance with an LTE protocol specified by a current 3GPP, the base station will initiate an uplink scheduling license (i.e., SR response) when an N+4^{th} sub-frame responds to the received uplink scheduling application from the terminal. The base station may perform channel assessment during the period of a CCA symbol set at a next sub-frame (i.e., N+5^{th} sub-frame). Time domain positions of multiple OFDM symbols for CCA may be set by a protocol or configured through network RRC signaling. When it is assessed that the unlicensed carrier channel is free through the CCA, the base station starts to send a certain signal (e.g., a signal having a similar format to an assessment reference signal, a synchronizing signal or a demodulation reference signal) set by the protocol from a first OFDM symbol after a CCA time period to retain occupation for the unlicensed carrier until uplink transmission officially begins (N+8^{th} sub-frame as illustrated in FIG. 3). It will be appreciated that depending on a terminal processing capability, processing time delays needed for the terminal to parse the uplink scheduling license sent by the base station are different. Therefore, the terminal may start to perform uplink transmission sooner or later, but the time will not be earlier than a first sub-frame after the CCA. For example, in the example of FIG. 3, the terminal may start to perform uplink transmission from an N+6^{th} sub-frame at the soonest. Preferably, no matter the terminal officially starts to perform uplink transmission at an expected sub-frame (e.g., N+8^{th} sub-frame) or not, transmission of a certain signal for channel reservation will last until a set maximum time is reached, and when the signal is continuously transmitted to reach the maximum time, a corresponding timer will expire to trigger to stop transmission of the signal.

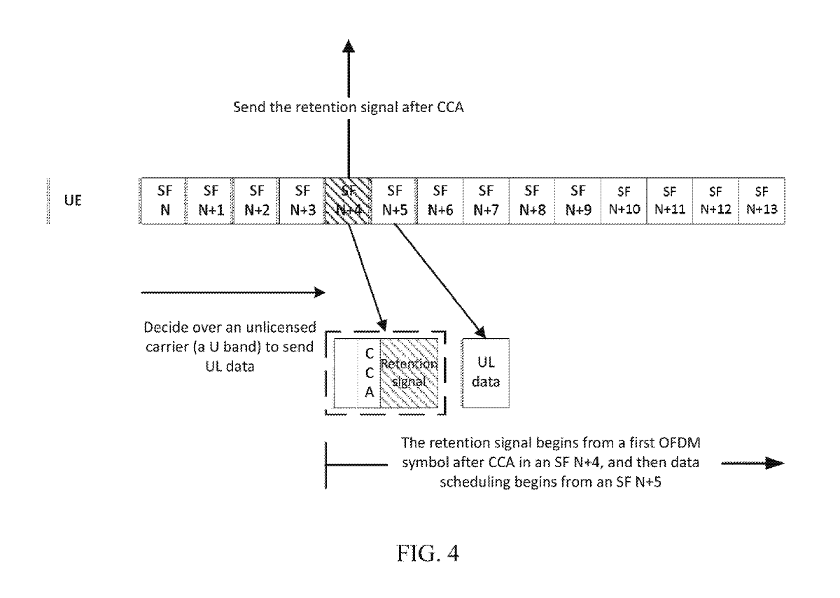

The third example of the present invention will be described hereinbelow with reference to FIG. 4. FIG. 4 illustrates a time sequence diagram of an uplink channel reservation method according to a fourth example of an embodiment of the present invention. In the present embodiment, channel assessment over an unlicensed carrier is initiated by a terminal at any time, and accordingly, the terminal sends a certain signal over the unlicensed carrier to retain a channel until the terminal starts to perform uplink signal transmission. This is an idea for an LAA device to intercept an unlicensed carrier channel at a network side and to perform transmission by utilizing the unlicensed carrier channel, namely an occupation-whilst-in use form, which is not on the premise of receiving network scheduling. As illustrated in FIG. 4, when the terminal decides to perform uplink transmission over an unlicensed carrier resource, the terminal may perform channel assessment during the period of a CCA symbol set for a next sub-frame. Time domain positions of multiple OFDM symbols for CCA may be set by a protocol or configured through network RRC signaling. When it is assessed that the unlicensed carrier channel is free through the CCA, the terminal starts to send a certain signal (e.g., an assessment reference signal) set by the protocol from a first OFDM symbol after a CCA time period to retain occupation for the unlicensed carrier until a previous sub-frame with respect to a sub-frame where uplink transmission officially begins is ended. That is, the terminal will continuously perform transmission for channel reservation from a first OFDM symbol after a CCA time-of-duration period until the terminal officially starts to perform uplink transmission. Where, the time when the terminal starts to perform uplink transmission will not be earlier than an ending point of a sub-frame for CCA. That is, sending of the channel reservation signal will last, at least, until the sub-frame for CCA is ended. Certainly, no matter whether the terminal officially starts to perform uplink transmission at an expected sub-frame, transmission of a certain signal for channel reservation will last until a certain set maximum time is reached. When the signal is continuously transmitted to reach the maximum time, a corresponding timer will expire to trigger to stop transmission of the signal.

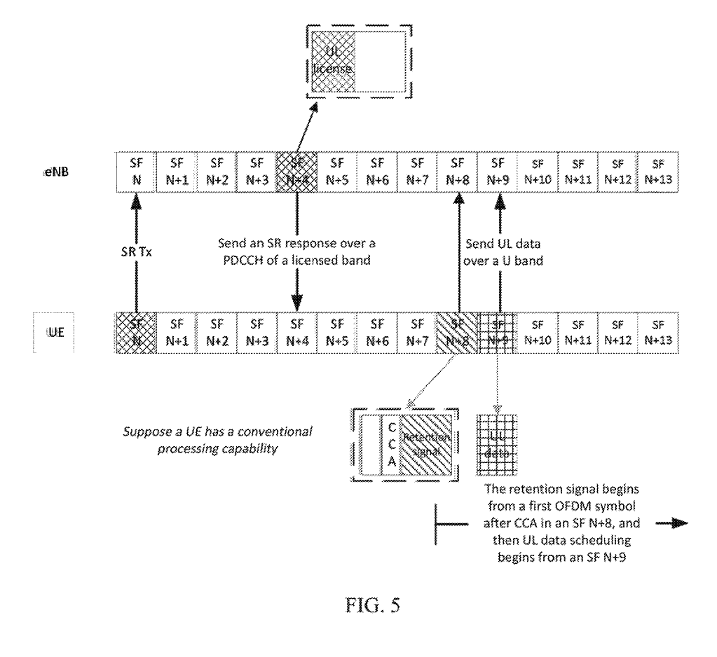

The fourth example of the present invention will be described hereinbelow with reference to FIG. 5. FIG. 5 illustrates a time sequence diagram of an uplink channel reservation method according to a fourth example of an embodiment of the present invention. In the present embodiment, channel assessment over an unlicensed carrier is executed when a terminal receives an uplink scheduling instruction from a base station after eight sub-frames after an uplink scheduling application is sent, and the terminal sends a certain signal over the unlicensed carrier to retain a channel until the terminal starts to perform uplink signal transmission. This is another idea for an LAA device to intercept an unlicensed carrier channel at a network side and to perform transmission by utilizing the unlicensed carrier channel. That is, the LAA device retains the unlicensed carrier channel on the basis of an uplink scheduling license response. As illustrated in FIG. 5, the terminal initiates an uplink scheduling application to the base station at a certain sub-frame, the number of the sub-frame being marked as N. If the base station agrees with the scheduling application of the terminal in accordance with an LTE protocol specified by a current 3GPP, the base station will respond to the received uplink scheduling application sent by the terminal at an N+4^{th} sub-frame, namely the base station will initiate a scheduling license to the terminal. The base station may perform channel assessment during the period of a CCA symbol set at an N+8^{th} sub-frame. Time domain positions of multiple OFDM symbols for CCA may be set by a protocol or configured through network RRC signaling. When it is assessed that the unlicensed carrier channel is free through the CCA, the terminal starts to send a certain signal (e.g., an assessment reference signal) set by the protocol from a first OFDM symbol after a CCA time period to retain occupation for the unlicensed carrier until uplink transmission officially begins. That is, the terminal will continuously perform transmission for channel reservation from a first OFDM symbol after a CCA time-of-duration period until the terminal officially starts to perform uplink transmission. The transmission will last before a first sub-frame after a CCA time of duration. Where, the time when the terminal starts to perform uplink transmission will not be earlier than an ending point of a sub-frame for CCA. That is, sending of the channel reservation signal will last, at least, until the sub-frame for CCA is ended. Certainly, no matter whether the terminal officially starts to perform uplink transmission at an expected sub-frame (e.g., N+8^{th} sub-frame), transmission of a certain signal for channel reservation will last until a certain set maximum time is reached. When the signal is continuously transmitted to reach the maximum time, a corresponding timer will expire to trigger to stop transmission of the signal.

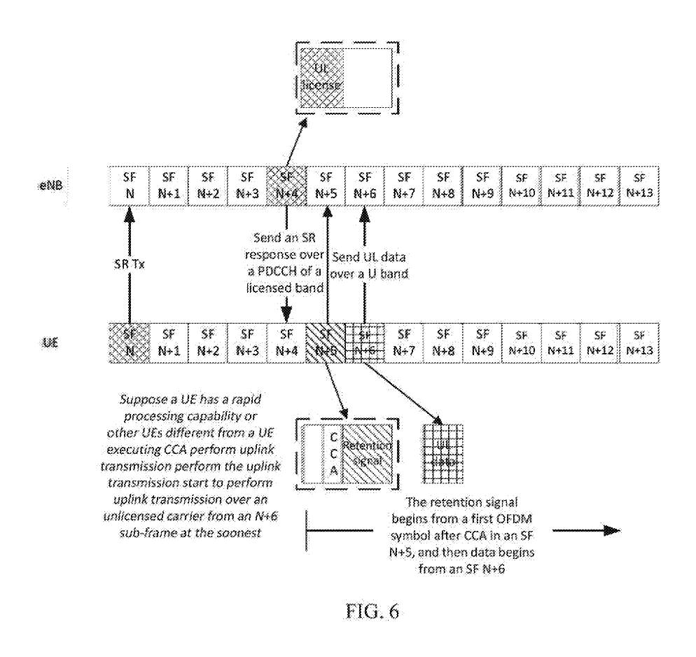

The fifth example of the present invention will be described hereinbelow with reference to FIG. 6. FIG. 6 illustrates a time sequence diagram of an uplink channel reservation method according to a fifth example of an embodiment of the present invention. In the present example, channel assessment over an unlicensed carrier is initiated by a terminal after a base station sends uplink scheduling, and the terminal applying for an uplink resource sends a certain signal over the unlicensed carrier so as to retain a channel. The terminal or other terminals of the present cell start to perform uplink transmission from a sub-frame after a sub-frame corresponding to a channel assessment time period. This is another time sequence, similar to the fourth example, for an LAA device to intercept an unlicensed carrier channel at a network side and to perform transmission by utilizing the unlicensed carrier channel. That is, the LAA device retains the unlicensed carrier channel on the basis of an uplink scheduling license response. As illustrated in FIG. 6, the terminal initiates an uplink scheduling application to the base station at a certain sub-frame, the number of the sub-frame being marked as N. If the base station agrees with the scheduling application of the terminal in accordance with an LTE protocol specified by a current 3GPP, the base station will respond to the received uplink scheduling application sent by the terminal at an N+4^{th} sub-frame, namely the base station will initiate a scheduling license to the terminal. The base station may perform channel assessment during the period of a CCA symbol set at a next sub-frame (i.e., N+5^{th} sub-frame). Time domain positions of multiple OFDM symbols for CCA may be set by a protocol or configured through network RRC signaling. When it is assessed that the unlicensed carrier channel is free through the CCA, the terminal starts to send a certain signal (e.g., an assessment reference signal) set by the protocol from a first OFDM symbol after a CCA time period to retain occupation for the unlicensed carrier until uplink transmission officially begins. The terminal will continuously perform transmission for channel reservation from a first OFDM symbol after a CCA time-of-duration period until the terminal officially starts to perform uplink transmission, where the terminal confirms that starting time of uplink transmission will not be earlier than a first sub-frame (i.e., N+6^{th} sub-frame) after the CCA time of duration. That is, uplink transmission over the assessed free unlicensed carrier resource may officially begin from the N+6^{th} sub-frame at the soonest. It is important to note that the terminal for performing the unlicensed carrier channel assessment may perform uplink transmission over the unlicensed carrier channel at the N+6^{th} sub-frame. The terminal capability may be strong, and the terminal may parse the uplink scheduling license signaling transmitted by the base station under a processing delay smaller than four sub-frames (e.g., a sub-frame). Certainly, other terminals licensed by the base station may perform uplink transmission over the unlicensed carrier channel at the N+6^{th} sub-frame. In a word, the uplink transmission may be started from the N+6^{th} sub-frame at the soonest. Certainly, no matter whether the terminal officially starts to perform uplink transmission at an expected sub-frame (e.g., N+6^{th} sub-frame), transmission of a certain signal for channel reservation will last until a certain set maximum time is reached. When the signal is continuously transmitted to reach the maximum time, a corresponding timer will expire to trigger to stop transmission of the signal.

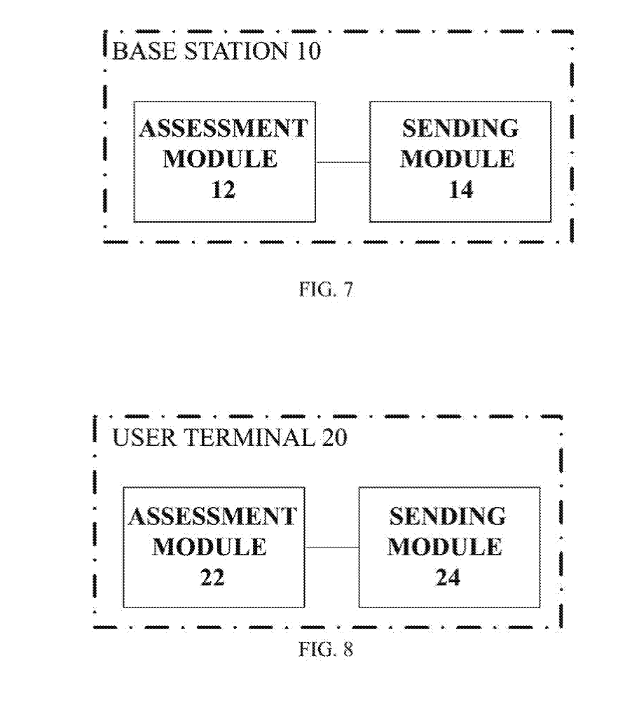

FIG. 7 illustrates a block diagram of a base station used in a communication system supporting an unlicensed carrier according to an embodiment of the present invention.

As illustrated in FIG. 7, a base station 10 may include an assessment module 12 and a sending module 14. The assessment module 12 may be configured to assess whether an unlicensed carrier resource is free. The sending module 14 may be configured to send a channel reservation signal over the assessed free unlicensed carrier resource.

Preferably, the base station 10 supports an LTE/LTE-A standard.

A signal format of the channel reservation signal may be a signal format defined in all LTE specifications such as an assessment reference signal, a synchronizing signal and a demodulation reference signal.

In some embodiments, the assessment module 12 may be configured to randomly initiate CCA. Alternatively, in some other embodiments, the assessment module 12 may be configured to make a decision according to an uplink scheduling license, and initiate the assessment at a specified time before or after a moment when the base station sends the uplink scheduling license.

The assessment module 12 may be configured to execute the CCA during the period of a CCA symbol. Specifically, the assessment module 12 may be configured to execute the CCA during the period of a CCA symbol of a current sub-frame that decides to perform uplink transmission over the unlicensed carrier resource. Alternatively, the assessment module 12 may be configured to execute the assessment during the period of a CCA symbol of a next frame with respect to a sub-frame for sending the uplink scheduling license.

The sending module 14 may be further configured to start to send the channel reservation signal over the assessed free unlicensed carrier resource from a first OFDM symbol after the CCA symbol until uplink transmission begins.

Preferably, the base station 10 further includes a timer, the timer being indicative of a maximum time of duration for sending the channel reservation signal. The sending module 14 may be further configured to continue sending the channel reservation signal last until uplink transmission begins or until the timer expires.

FIG. 8 illustrates a block diagram of a user terminal used in a communication system supporting an unlicensed carrier according to an embodiment of the present invention. As illustrated in FIG. 8, a user terminal 20 may include an assessment module 22 and a sending module 24. The assessment module 22 may be configured to assess whether an unlicensed carrier resource is free. The sending module 24 may be configured to send a channel reservation signal over the assessed free unlicensed carrier resource.

It will be appreciated that the user terminal 20 may have more modules such as some known functional modules provided for the existing user terminal. For example, the user terminal 20 further includes a data sending module, used for performing uplink transmission.

Preferably, the user terminal 20 supports an LTE/LTE-A standard.

A signal format of the channel reservation signal may be a signal format defined in all LTE specifications such as an assessment reference signal, a synchronizing signal and a demodulation reference signal.

In sonic embodiments, the assessment module 22 may be configured to randomly initiate CCA. Alternatively, in some other embodiments, the assessment module 22 may be configured to initiate, in response to the uplink scheduling license, the CCA at a specified time before or after a moment when the base station sends the uplink scheduling license.

The assessment module 22 may be configured to execute the CCA during the period of a CCA symbol. Specifically, the assessment module 22 may be configured to execute the CCA during the period of a CCA symbol of a current sub-frame that decides to perform uplink transmission over the unlicensed carrier resource.

Alternatively, the assessment module 22 may be configured to execute the assessment during the period of a CCA symbol of an M^{th} sub-frame after a corresponding sub-frame for sending the uplink scheduling license, where M is a positive integer greater than or equal to 1. The value of M may depend on a processing capability of the user terminal. When the user terminal has a rapid processing capability, a time delay for the terminal to parse the uplink scheduling license sent by the base station is short, and M may be endowed with a small value. When the user terminal has a common processing capability or a slow processing capability, a time delay for the terminal to parse the uplink scheduling license sent by the base station is long, and M may be endowed with a large value. Therefore, uplink transmission may be started over the unlicensed carrier channel from an M+1^{th} sub-frame after a corresponding sub-frame for sending the uplink scheduling license at the soonest. For example, as illustrated in FIG. 5, uplink transmission may be started over the unlicensed carrier channel from a second sub-frame after the corresponding sub-frame for sending the uplink scheduling license at the soonest.

The sending module 24 may be further configured to start to send the channel reservation signal over the assessed free unlicensed carrier resource from a first OFDM symbol after the CCA symbol until uplink transmission begins.

Preferably, the user terminal 20 further includes a tinier, the timer being indicative of a maximum time of duration for sending the channel reservation signal. The sending module 24 may be further configured to continue sending the channel reservation signal last until uplink transmission begins or until the timer expires.

Preferably, after the user terminal 20 assesses the free unlicensed carrier channel, a terminal for performing uplink transmission over the assessed free unlicensed carrier resource may be a terminal 20 for executing CCA, or may be other terminals accessing the present cell.

The base station 10 and the user equipment 20 according to the embodiments of the present invention may be configured to execute the channel reservation method of the present invention such as the method 100. The operations therefore will not be elaborated herein.

The present invention has been described above in conjunction with the preferable embodiments. A person skilled in the art may understand that the method and device described above are only exemplary. The method of the present invention is not limited to the steps and sequence described above. For example, the method of the present invention may include more optional steps. The device of the present invention is also not limited to the described components. For example, the device of the present invention may include components more than the described components. A person skilled in the art may make various changes and modifications according to instructions of the described embodiments.

It will be appreciated that the foregoing embodiments of the present invention may be implemented by software, hardware or combination of software and hardware. For example, various assemblies inside the base station and the user terminal in the foregoing embodiments may be implemented by various devices. These devices include, but are not limited to, an analog circuit device, a digital circuit device, a Digital Signal Processing (DSP) circuit, a programmable processor, an Application Specific Integrated Circuit (ASIC), a Field Programmable Gate Array (FPGA), a Complex Programmable Logic Device (CPLD), and the like.

In the present application, “base station” refers to a mobile communication data and control switching center having a higher transmitting power and a wider coverage area, including functions of resource allocation scheduling, data receiving and sending, and the like. “User terminal” refers to a user mobile terminal, including, for example, a terminal device capable of performing radio communications with the base station or a micro base station, such as a mobile phone and a notebook computer.

Besides, the embodiments of the present invention disclosed here may be implemented on a computer program product. More specifically, the computer program product is one of the following products: a computer-readable medium, the computer-readable medium encoding computer program logics, and when being executed on a computing device, the computer program logics providing relevant operations to achieve the foregoing technical solution of the present invention. When being executed on at least one processor of a computing system, the computer program logics enable the processor to execute the operations (method) according to the embodiments of the present invention. This setting of the present invention is typically provided as software, codes and/or other data structures set or encoded on a computer-readable medium such as an optical medium (e.g., CD-ROM), a floppy disk or a hard disk, or other media for firmware or micro-codes on, for example, one or more ROM or RAM or PROM chips, or downloadable software images, shared databases, and the like in one or more modules. Software or firmware or this configuration may be installed on a computing device, such that one or more processors in the computing device execute the technical solution described in the embodiments of the present invention.

The embodiments of the present invention provide a mechanism for ensuring that an unlicensed carrier resource remains free during the period from the time when an unlicensed carrier is assessed to be free to the time when an uplink license is issued and comes into effect by sending an unlicensed carrier resource reservation signal. The present invention also provides an exemplary form of a channel reservation signal. The embodiments of the present invention also provide various triggering mechanisms for sending an unlicensed carrier resource reservation signal. The present invention also provides a timing mechanism capable of ensuring that continuous sending of an unlicensed carrier resource reservation signal satisfies certain limiting conditions.

Although the present invention has been described above in conjunction with the preferable embodiments of the present invention, as will occur to a person skilled in the art, the present invention is susceptible to various modifications, replacements and changes without departing from the spirit and scope of the present invention. Therefore, the present invention shall not be limited by the foregoing embodiments, but shall be limited by the appended claims and equivalents instead.

1. An uplink channel reservation method used in a mobile communication system supporting an unlicensed carrier, comprising the steps of:
assessing whether an unlicensed carrier resource is free; and
sending a channel reservation signal over the assessed free unlicensed carrier resource.

2. The method according to claim 1, wherein the method is executed by a base station or a user terminal.

3. The method according to claim 1, wherein a signal format of the channel reservation signal comprises a signal format of one of the following signals: an assessment reference signal, a synchronizing signal, and a demodulation reference signal.

4. The method according to claim 1, wherein the mobile communication system comprises a Long Term Evolution (LTE) system and a Long Term Evolution Advanced (LTE-A) system.

5. The method according to claim 1, further comprising: setting a timer, the timer being indicative of a maximum time of duration for sending the channel reservation signal, wherein the channel reservation signal continues being sent until uplink transmission begins or until the timer expires.

6. The method according to claim 1, wherein the step of assessment is initiated randomly.

7. The method according to claim 1, wherein the step of assessment is initiated according to an uplink scheduling license.

8. The method according to claim 1, wherein the assessment is executed during the period of a Free Channel Assessment (CCA) symbol.

9. The method according to claim 8, wherein the step of sending comprises: starting to send the channel reservation signal over the assessed free unlicensed carrier resource from a first Orthogonal Frequency Division Multiplexing (OFDM) symbol after the CCA symbol.

10. The method according to claim 1, wherein the assessment is executed during the period of a CCA symbol of a current sub-frame that decides to perform uplink transmission over the unlicensed carrier resource.

11. The method according to claim 1, wherein the assessment is executed during the period of a CCA symbol of an M^{th} sub-frame after a corresponding sub-frame for sending the uplink scheduling license, M being a positive integer greater than or equal to 1.

12. The method according to claim 7, further comprising: performing uplink transmission over the assessed free unlicensed carrier resource, wherein a terminal for executing the uplink transmission is a user terminal for executing the step of assessment, or other user terminals accessing the present cell.

13. A base station, comprising:
an assessment module, configured to assess whether an unlicensed carrier resource is free; and
a sending module, configured to send a channel reservation signal over the assessed free unlicensed carrier resource.

14. The base station according to claim 13, wherein the base station supports a Long Term Evolution (LTE) or Long Term Evolution Advanced (LTE-A) standard.

15. The base station according to claim 13, further comprising: a timer, the timer being indicative of a maximum time of duration for sending the channel reservation signal,
wherein the sending module is further configured to continue sending the channel reservation signal until uplink transmission begins or until the timer expires.

16. The base station according to claim 13, wherein the assessment module is configured to randomly initiate the assessment.

17. The base station according to claim 13, wherein the assessment module is configured to make a decision according to an uplink scheduling license, and initiate the assessment at a specified time before or after a moment when the base station sends the uplink scheduling license.

18. The base station according to claim 13, wherein the assessment module is configured to execute the assessment during the period of a Free Channel Assessment (CCA) symbol.

19. The base station according to claim 18, wherein the sending module is further configured to start to send the channel reservation signal over the assessed free unlicensed carrier resource from a first Orthogonal Frequency Division Multiplexing (OFDM) symbol after the CCA symbol.

20. The base station according to claim 13, wherein the assessment module is further configured to execute the assessment during the period of a CCA symbol of a current sub-frame that decides to perform uplink transmission over the unlicensed carrier resource.

21. The base station according to claim 13, wherein the assessment module is further configured to execute the assessment during the period of a CCA symbol of a next frame with respect to a sub-frame for sending the uplink scheduling license.

22. A user terminal, comprising:
an assessment module, configured to assess whether an unlicensed carrier resource is free; and
a sending module, configured to send a channel reservation signal over the assessed free unlicensed carrier resource.

23. The user terminal according to claim 22, wherein a signal format of the channel reservation signal comprises a signal format of one of the following signals: an assessment reference signal, a synchronizing signal, and a demodulation reference signal.

24. The user terminal according to claim 22, wherein the user terminal supports a Long Term Evolution (LTE) or Long Term Evolution Advanced (LTE-A) standard.

25. The user terminal according to claim 22, wherein the sending module is further configured to:
set a timer, the timer being indicative of a maximum time of duration for sending the channel reservation signal; and
continue sending the channel reservation signal until uplink transmission begins or until the timer expires.

26. The user terminal according to claim 22, wherein the assessment module is configured to randomly initiate the assessment.

27. The user terminal according to claim 22, wherein the assessment module is configured to initiate, in response to an uplink scheduling license, the assessment.

28. The user terminal according to claim 22, wherein the assessment module is configured to execute the assessment during the period of a Free Channel Assessment (CCA) symbol.

29. The user terminal according to claim 28, wherein the sending module is further configured to start to send the channel reservation signal over the assessed free unlicensed carrier resource from a first Orthogonal Frequency Division Multiplexing (OFDM) symbol after the CCA symbol.

30. The user terminal according to claim 22, wherein the assessment module is further configured to execute the assessment during the period of a CCA symbol of a current sub-frame that decides to perform uplink transmission over the unlicensed carrier resource.

31. The user terminal according to claim 22, wherein the assessment module is further configured to execute the assessment during the period of a CCA symbol of an M^{th} sub-frame after a corresponding sub-frame for sending the uplink scheduling license, M being a positive integer greater than or equal to 1.

32. The user terminal according to claim 31, further comprising: a data sending module, configured to start to perform uplink transmission over an unlicensed carrier channel through an M+1^{th} sub-frame after a corresponding sub-frame for sending the uplink scheduling license.
